(19) United States
(12) Patent Application Publication
(10) Pub. No.: US 2020/0128608 A1
(43) Pub. Date: Apr. 23, 2020

(54) CONTEXT RELEASE METHOD, DEVICE AND SYSTEM

(71) Applicant: GUANGDONG OPPO MOBILE TELECOMMUNICATIONS CORP., LTD., Dongguan, Guangdong (CN)

(72) Inventor: Ning YANG, Dongguan (CN)

(73) Assignee: GUANGDONG OPPO MOBILE TELECOMMUNICATIONS CORP., LTD., Dongguan, Guangdong (CN)

(21) Appl. No.: 16/474,014

(22) PCT Filed: Dec. 29, 2016
(86) PCT No.: PCT/CN2016/112970

§ 371 Date: Jun. 26, 2019

(51) Int. Cl. H04W 76/30; H04W 76/25; H04W 76/27; H04W 76/19

(52) U.S. Cl. CPC H04W 76/30; H04W 76/19; H04W 76/27; H04W 76/25

(57) ABSTRACT

Provided are a context release method, device and system, which are related to the field of applications of communication technologies. The method includes that: a terminal sends a context release request to a first base station, the context release request being used for indicating a network side to release a related context of the terminal. In this way, complex context release flow is avoided, signaling interaction between the terminal and the network side may be effectively reduced, the signaling overhead is reduced, and the whole flow is simplified. The application is applied to context release in a mobile communication system.

### TECHNICAL FIELD

The disclosure relates to the field of applications of communication technologies, and particularly to a context release method, device and system.

### BACKGROUND

Along with development of the society and advance of sciences and technologies, users have made higher requirements on mobile terminal access technologies. In a Long Term Evolution (LTE) system of a 4rd-Generation (4G) mobile communication system and a 5th-Generation (5G) mobile communication system, besides an idle state and a connected state well known to all, an inactive state is introduced. In an inactive state, a terminal may move between cells, without measurement switching, within a certain region according to Mobile Management (MM) which is adopted in an idle state, meanwhile, a related context of the terminal and an initial base station is the same as that in a connected state, and the related context is stored in the terminal and on a network side (at least stored in the initial base station on the network side) respectively. Here, the initial base station is a base station to which a cell where the terminal having not yet been switched to the inactive state is located belongs.

If a terminal is required by a network side to be switched from an inactive state to an idle state, the terminal may be controlled through a paging message to be switched from the inactive state to a connected state, then the terminal is controlled through a Radio Resource Control (RRC) connection release message to be switched from the connected state to the idle state and release the related context of the terminal and the initial base station, and correspondingly, the network side also releases the stored related context.

However, in such a method for context release in an inactive state, a network side and a terminal are required to interact via many messages so as to release the context, and the whole flow is thus complex.

### SUMMARY

In order to solve the problem that the context release process is complex, the disclosure provides a context release method, device and system. The following technical solutions are adopted.

A first aspect provides a context release method, which may include the following operation.

A terminal sends a context release request to a first base station, the context release request being used for indicating a network side to release a related context of the terminal.

Optionally, after the operation that the terminal sends the context release request to the first base station, the method may further include the following operation.

The terminal receives a context release response sent by the first base station.

Optionally, before the operation that the terminal sends the context release request to the first base station, the method may further include the following operation.

An application layer or Non-Access Stratum (NAS) of the terminal determines that the terminal is required to be switched from an inactive state to an idle state.

Optionally, the operation that the terminal sends the context release request to the first base station may comprise the following operation.

The terminal sends the context release request to the first base station through an Access Stratum (AS).

Optionally, the context release request may be an RRC Connection Resume Request containing a release indication; or, the context release request may be an RRC connection recovery request containing a release indication; or, the context release request may be an RRC Connection Resume Complete message containing a release indication; or, the context release request may be an RRC connection recovery completion request containing a release indication.

Here, the release indication may be for indicating the network side to release the related context of the terminal.

A second aspect provides a context release method, which may include the following operation.

A first base station receives a context release request sent by a terminal, the context release request being used for indicating a network side to release a related context of the terminal.

Optionally, after the operation that the first base station receives the context release request sent by the terminal, the method may further include the following operations.

The first base station triggers a network-side device storing the related context to release the related context according to the context release request.

The first base station sends a context release response to the terminal, the context release response being used for triggering the terminal to release the related context.

Optionally, the operation that the first base station triggers the network-side device storing the related context to release the related context according to the context release request may include the following operation.

The first base station sends context release indication information to the network-side device according to the context release request, the context release indication information being used for indicating the network-side device to release the related context.

The operation that the first base station sends the context release response to the terminal may include the following operations.

The first base station receives context release completion information sent by the network-side device, the context release completion information being used for indicating that the network-side device has completed releasing the related context.

The first base station sends the context release response to the terminal according to the context release completion information.

Optionally, the operation that the first base station triggers the network-side device storing the related context to release the related context according to the context release request may include the following operation.

The first base station sends a context release authorization request to a core management device according to the context release request, the context release authorization request being used for requesting for authorizing the network-side device to release the related context.

The operation that the first base station sends the context release response to the terminal may include the following operations.

The first base station receives the context release completion information sent by the core management device, the context release completion information being sent by the core management device after the core management device triggers the network-side device to release the related context and being used for indicating that the network-side device has completed releasing the related context.

The first base station sends the context release response to the terminal according to the context release completion information.

Optionally, the operation that the first base station triggers the network-side device storing the related context to release the related context according to the context release request may include the following operation.

The first base station sends the context release authorization request to the core management device according to the context release request, the context release authorization request being used for requesting for authorizing the network-side device to release the related context.

The first base station receives a context release authorization response sent by the core management device, the context release authorization response being used for indicating that the network-side device is allowed to release the related context.

The first base station sends the context release indication information to the network-side device according to the context release authorization response, the context release indication information being used for indicating the network-side device to release the related context.

The operation that the first base station sends the context release response to the terminal may include the following operations.

The first base station receives the context release completion information sent by the network-side device, the context release completion information being used for indicating that the network-side device has completed releasing the related context.

The first base station sends the context release response to the terminal according to the context release completion information.

Optionally, the context release request may be an RRC Connection Resume Request containing a release indication; or, the context release request may be an RRC connection recovery request containing a release indication; or, the context release request may be an RRC Connection Resume Complete message containing a release indication; or, the context release request may be an RRC connection recovery completion request containing a release indication.

Here, the release indication may be for indicating the network side to release the related context of the terminal.

Optionally, the context release request may be sent by the terminal accessing the first base station after determining that the terminal is required to be switched from an inactive state to an idle state.

Optionally, the network-side device may include an initial base station, and/or a management device of a Core Network, and/or a network-side central control node.

The initial base station may be a base station to which a cell where the terminal having not yet been switched to the inactive state is located belongs.

A third aspect provides a context release method, which may include the following operation.

A core management device receives a context release authorization request sent by a first base station, the context release authorization request being sent by the first base station after the first base station receives a context release request from a terminal and the context release request being used for indicating a network side to release a related context of the terminal.

Optionally, after the operation that the core management device receives the context release authorization request sent by the first base station, the method may further include the following operations.

The core management device triggers a network-side device storing the related context to release the related context according to the context release authorization request.

The core management device sends context release completion information to the first base station after the network-side device releases the related context, the context release completion information being used for indicating that the network-side device has completed releasing the related context.

Optionally, the operation that the core management device triggers the network-side device storing the related context to release the related context according to the context release authorization request may include the following operation.

The core management device sends context release indication information to the network-side device according to the context release authorization request, the context release indication information being used for indicating the network-side device to release the related context.

The operation that the core management device sends the context release completion information to the first base station after the network-side device releases the related context may include the following operations.

The core management device receives the context release completion information sent by the network-side device, the context release completion information being used for indicating that the network-side device has completed releasing the related context.

The core management device sends the context release completion information to the first base station according to the context release completion information.

Optionally, after the operation that the core management device receives the context release authorization request sent by the first base station, the method may further include the following operations.

The core management device generates a context release authorization response according to the context release authorization request, the context release authorization response being used for indicating that the network-side device storing the related context is allowed to release the related context.

The core management device sends the context release authorization response to the first base station.

Optionally, the context release request may be sent by the terminal in a cell managed by the first base station after determining that the terminal is required to be switched from an inactive state to an idle state.

Optionally, the network-side device may comprise an initial base station, and/or, a management device of a core network, and/or, a network-side central control node.

The initial base station may be a base station to which a cell where the terminal having not yet been switched to the inactive state is located belongs.

A fourth aspect provides a context release device, which may include a transmitting module.

The transmitting module may be configured to send a context release request to a first base station, the context release request being used for indicating a network side to release a related context of a terminal.

Optionally, the device may further include a receiving module, configured to receive a context release response sent by the first base station.

Optionally, the device may further include a determination module.

The determination module may be configured to determine, through an application layer or a NAS, that the terminal is required to be switched from an inactive state to an idle state.

Optionally, the transmitting module may specifically be configured to:

send the context release request to the first base station through an AS.

Optionally, the context release request may be an RRC Connection Resume Request containing a release indication; or, the context release request may be an RRC connection recovery request containing a release indication; or, the context release request may be an RRC Connection Resume Complete message containing a release indication; or, the context release request may be an RRC connection recovery completion request containing a release indication.

Here, the release indication may be for indicating the network side to release the related context of the terminal.

A fifth aspect provides a context release device, which may include a receiving module.

The receiving module may be configured to receive a context release request sent by a terminal, the context release request being used for indicating a network side to release a related context of the terminal.

Optionally, the device may further include a triggering module and a transmitting module.

The triggering module may be configured to trigger a network-side device storing the related context to release the related context according to the context release request.

The transmitting module may be configured to send a context release response to the terminal, the context release response being configured to trigger the terminal to release the related context.

Optionally, the triggering module may specifically be configured to:

send context release indication information to the network-side device according to the context release request, the context release indication information being used for indicating the network-side device to release the related context.

The transmitting module may specifically be configured to:

receive context release completion information sent by the network-side device, the context release completion information being used for indicating that the network-side device has completed releasing the related context, and

send the context release response to the terminal according to the context release completion information.

Optionally, the triggering module may specifically be configured to:

send a context release authorization request to a core management device according to the context release request, the context release authorization request being configured to request for authorizing the network-side device to release the related context.

The transmitting module may specifically be configured to:

receive the context release completion information sent by the core management device, the context release completion information being sent by the core management device after triggering the network-side device to release the related context and being used for indicating that the network-side device has completed releasing the related context, and

send the context release response to the terminal according to the context release completion information.

Optionally, the triggering module may specifically be configured to:

send the context release authorization request to the core management device according to the context release request, the context release authorization request being configured to request for authorizing the network-side device to release the related context,

receive a context release authorization response sent by the core management device, the context release authorization response being used for indicating that the network-side device is allowed to release the related context, and

send the context release indication information to the network-side device according to the context release authorization response, the context release indication information being used for indicating the network-side device to release the related context.

The transmitting module may specifically be configured to:

receive the context release completion information sent by the network-side device, the context release completion information being used for indicating that the network-side device has completed releasing the related context, and

send the context release response to the terminal according to the context release completion information.

Optionally, the context release request may be an RRC Connection Resume Request containing a release indication; or, the context release request may be an RRC connection recovery request containing a release indication; or, the context release request may be an RRC Connection Resume Complete message containing a release indication; or, the context release request may be an RRC connection recovery completion request containing a release indication.

Here, the release indication may be for indicating the network side to release the related context of the terminal.

Optionally, the context release request may be sent by the terminal accessing a first base station after determining that the terminal is required to be switched from an inactive state to an idle state.

Optionally, the network-side device may include an initial base station, and/or, a management device of a core network, and/or, a network-side central control node.

The initial base station may be a base station to which a cell where the terminal having not yet been switched to the inactive state is located belongs.

A sixth aspect provides a context release device, which may include a receiving module.

The receiving module may be configured to receive a context release authorization request sent by a first base station, the context release authorization request being sent by the first base station after the first base station receives a context release request sent by a terminal and the context release request being used for indicating a network side to release a related context of the terminal.

Optionally, the device may further include a triggering module and a transmitting module.

The triggering module may be configured to trigger a network-side device storing the related context to release the related context according to the context release authorization request.

The transmitting module may be configured to send context release completion information to the first base station after the network-side device releases the related context, the context release completion information being used for indicating that the network-side device has completed releasing the related context.

Optionally, the triggering module may specifically be configured to:

send context release indication information to the network-side device according to the context release authorization request, the context release indication information being used for indicating the network-side device to release the related context.

The transmitting module may specifically be configured to:

receive the context release completion information sent by the network-side device, the context release completion information being used for indicating that the network-side device has completed releasing the related context, and

send the context release completion information to the first base station according to the context release completion information.

Optionally, the device may further include a generation module and a transmitting module.

The generation module may be configured to generate a context release authorization response according to the context release authorization request, the context release authorization response being used for indicating that the network-side device storing the related context is allowed to release the related context.

The transmitting module may be configured to send the context release authorization response to the first base station.

Optionally, the context release request may be sent by the terminal in a cell managed by the first base station after determining that the terminal is required to be switched from an inactive state to an idle state.

Optionally, the network-side device may include an initial base station, and/or a management device of a core network, and/or a network-side central control node.

The initial base station may be a base station to which a cell where the terminal having not yet been switched to the inactive state is located belongs.

A seventh aspect provides a context release system, which may include a terminal and a first base station.

The terminal may include any context release device of the fourth aspect.

The first base station may include any context release device of the fifth aspect.

Optionally, the system may further include any context release device of the sixth aspect.

According to the context release method, device and system provided in the embodiments of the disclosure, a terminal triggers a network side to release a related context, and in a context release process, particularly a context release process in an inactive state, switching to a connected state for switching to the idle state is avoided, so that signaling interaction between the terminal and the network side is effectively reduced, a signaling overhead is reduced, and the whole flow is simplified.

It is to be understood that the above general description and the following detailed description are only exemplary and explanatory and not intended to limit the disclosure.

### BRIEF DESCRIPTION OF DRAWINGS

In order to describe the technical solutions of the embodiments of the disclosure more clearly, the drawings used in descriptions about the embodiments will be simply introduced below. The drawings described below only illustrate some embodiments of the disclosure. Other drawings may further be obtained by those of ordinary skill in the art according to these drawings without creative work.

FIG. 1 is a schematic diagram of an implementation environment of a context release system involved in a context release method according to part of embodiments of the disclosure.

FIG. 2-1 is a flowchart of a context release method according to an embodiment of the disclosure.

FIG. 2-2 is a flowchart of a method for establishing an RRC connection between a terminal and a first base station according to an embodiment of the disclosure.

FIG. 3-1 is a flowchart of another context release method according to an embodiment of the disclosure.

FIG. 3-2 is a flowchart of the operation that a core management device triggers a network-side device to release a related context according to an embodiment of the disclosure.

FIG. 3-3 is a flowchart of the operation that a core management device sends context release completion information to a first base station according to an embodiment of the disclosure.

FIG. 4 is a flowchart of another context release method according to an embodiment of the disclosure.

FIG. 5-1 is a block diagram of a context release device according to a schematic embodiment of the disclosure.

FIG. 5-2 is a block diagram of another context release device according to a schematic embodiment of the disclosure.

FIG. 5-3 is a block diagram of another context release device according to a schematic embodiment of the disclosure.

FIG. 6-1 is a block diagram of a context release device according to another schematic embodiment of the disclosure.

FIG. 6-2 is a block diagram of another context release device according to another schematic embodiment of the disclosure.

FIG. 7-1 is a block diagram of a context release device according to another schematic embodiment of the disclosure.

FIG. 7-2 is a block diagram of another context release device according to another schematic embodiment of the disclosure.

FIG. 7-3 is a block diagram of another context release device according to another schematic embodiment of the disclosure.

FIG. 8 is a structure diagram of a context release device according to a schematic embodiment of the disclosure.

Specific embodiments of the disclosure have been shown in the drawings, and more detailed descriptions will be made hereinafter. These drawings and text descriptions are adopted not to limit the scope of the concept of the disclosure in any manner but to describe the concept of the disclosure to those skilled in the art with reference to the specific embodiments.

### DETAILED DESCRIPTION

In order to make the purpose, technical solutions and advantages of the disclosure clearer, the implementation modes of the disclosure will further be described below in combination with the drawings in detail.

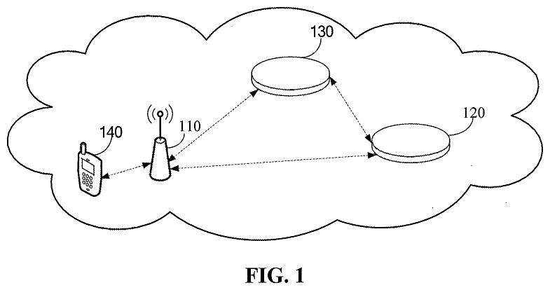

FIG. 1 is a schematic diagram of an implementation environment of a context release system involved in a context release method according to part of embodiments of the disclosure. The context release system may be an LTE system or a 5G mobile communication system, or a heterogeneous network where multiple mobile communication systems coexist, etc. The implementation environment may include a first base station 110, a network-side device 120, a core management device 130 and a terminal 140. Here, the terminal 140 may communicate with the first base station 110, the first base station 110 may communicate with the network-side device 120 and the core management device 130 respectively, and the network-side device 120 may communicate with the core management device 130.

In the embodiments of the disclosure, the network-side device 120 may refer to a base station, and/or, a management device of a core network (core network) (for example, a Mobility Management Entity (MME) in LTE), and/or, a network-side central control node. The base station may at least include an initial base station, and the initial base station is a base station to which a cell where the terminal having not yet been switched to an inactive state is located belongs. The core management device 130 may be a server, or a server cluster consisting of a plurality of servers, or a cloud computing service center. In the embodiments of the disclosure, the core management device may be a device in a generalized concept, which may be a management device, or a management device cluster, or multiple management device clusters. Exemplarily, in the LTE system, the core management device may be an MME, or may also be an MME cluster or multiple MME clusters. The core management device 130 may manage the first base station 110 and/or the network-side device 120. The terminal 140 may be a smart phone, a computer, a multimedia player, an electronic reader, a wearable device and the like. Here, a related context of the terminal is stored in the network-side device 120 and the terminal 140, and the related context may be part or all of contexts related to the terminal. The related context may include present bear information, Quality of Service (QoS) information, security context and other information related to the terminal. For example, the security context may include a network key, a NAS number and the like.

In the implementation environment, the core management device 130 and the first base station 110 may represent different devices in different mobile communication systems. For example, in a LTE system, the core management device 130 may be one or more MMEs of the core network, and the first base station 110 may be an Evolved Node B (eNB). In a 5G mobile communication system, the core management device 130 may be one or more management devices of the core network, and the first base station 110 may be a Generation Node B (gNB).

In the implementation environment, the terminal usually has three states: an idle state, a connected state and an inactive state. Here, the idle state refers to a state that a terminal is powered on but does not establish an RRC connection with a wireless network. The connected state refers to a state that a terminal is powered on and establishes an RRC connection with a wireless network. The inactive state is a status between the idle state and the connected state. In the inactive state, an MM manner for the terminal is the same as that adopted in the idle state, and the related context of the terminal and the initial base station is the same as that in the connected state.

In the embodiments of the disclosure, there is made such a hypothesis that the terminal 140 is in an inactive state and a network-side device which stores the related context of the terminal before switching to the inactive state is the network-side device 120. Since the terminal in the inactive state may move between cells within a certain region (which may be a range preset by a network side), if a cell where the terminal 140 is located belongs to the first base station 110 (the first base station 110 may be or may be not the initial base station, which will not be limited in the embodiments of the disclosure), after the terminal determines to switch from the inactive state to the idle state, the terminal 140 may actively trigger the network side to execute a flow for context release to enable the network-side device 120 storing the context of the terminal to release the related context. Specifically, the terminal sends to the first base station a context release request which is used for indicating the network side to release the related context of the terminal, the first base station triggers the network-side device to release the related context according to the context release request and, after the network-side device releases the related context, feeds back a context release response to the terminal, and the terminal, after receiving the context release response from the first base station, may release the related context in the terminal.

In the embodiments of the disclosure, the terminal may send the context release request, and the first base station triggers the network-side device to release the related context according to the context release request. Here, the first base station may trigger the network-side device to release the related context after permitted by the core management device, or may indirectly trigger the network-side device to release the related context through the core management device, or may directly trigger the network-side device to release the related context. The embodiments of the disclosure will be described with the following aspects as examples.

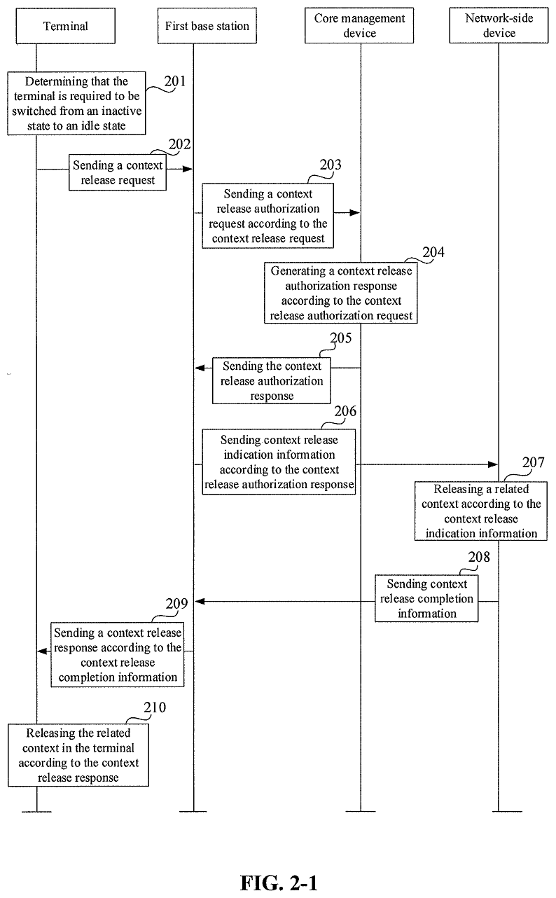

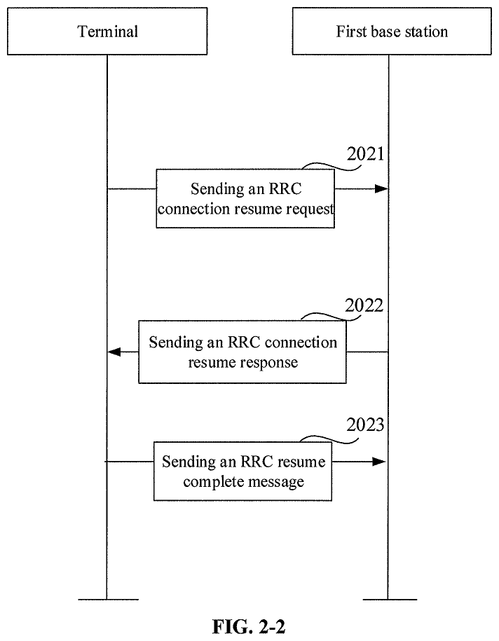

On a first aspect, the first base station may trigger the network-side device to release the related context after getting permission from the core management device, which, as shown in FIG. 2-1, specifically includes the following steps.

In Step 201, a terminal determines that the terminal is required to be switched from an inactive state to an idle state.

In the embodiment of the disclosure, it may be determined by a higher layer, for example, an application layer or a NAS, of the terminal that the terminal is required to be switched from an inactive state to an idle state.

Here, the application layer is a higher layer for interacting with a user (that is, the application layer is oriented to a user), which is mainly for directly providing service for an application process of a user. The application layer may specify a protocol that the application process follows during communication. Each application program managed by the application layer runs in its own process and usually has an independent virtual machine.

In a protocol stack, the flow of the NAS is a signaling flow required to be processed by a terminal (also called User Equipment (UE)) and a core network (called CN for short hereinafter). An RRC and Radio Access Network Application Part (RANAP) layer and a protocol layer below it are called an Access Stratum (AS); and MM, Call Control (CC), Short Message Service (SMS) and the like are called an NAS.

In the embodiment of the disclosure, the application layer may detect a running state of a network application (i.e., an application for interacting with a network side, for example, an instant messaging application) in the terminal (specifically, a process of the application may be monitored) and determine whether the terminal is required to be switched from an inactive state to an idle state or not according to the running state. For example, when there is at least one network application in an on state in the terminal, the application layer may determine that the terminal is not required to be switched from an inactive state to an idle state, while when all network applications in the terminal are in an off state, the application layer may determine that the terminal is required to be switched from the inactive state to the idle state.

Exemplarily, a specific scenario may be as follows. When the terminal is in the inactive state, if the application layer detects by monitoring that a certain network application, for example, a web browser, in the terminal is turned on at present, the application layer may determine, according to a preset rule, that a user is operating the network application and the terminal may subsequently transmit data with the network side to respond to a corresponding user operation, and then the application layer determine that the terminal may be required to subsequently transmit data, so that the terminal is not required to be switched from the inactive state to the idle state, and the terminal is kept in the inactive state, and when data is required to be transmitted, the terminal may be switched to a connected state. If the application layer detects by monitoring that a certain network application, for example, a web browser, in the terminal is turned off at present, the application layer may determine, according to the preset rule, that the user does not operate the network application anymore and the terminal may subsequently be not required to transmit data with the network side to respond to a user operation, and then the application layer determines that the terminal may be not required to subsequently transmit data, so that the terminal may be switched from the inactive state to the idle state to cut off a connection between the terminal and the network side and reduce energy consumption of the terminal.

The NAS may detect a transmission/reception state of NAS signaling in the terminal and determine whether the terminal is required to be switched from the inactive state to the idle state or not according to the transmission/reception state. For example, when there is at least one piece of NAS signaling to be transmitted/received in the terminal, the NAS may determine that the terminal is not required to be switched from the inactive state to the idle state, and when there is no NAS signaling to be transmitted/received in the terminal, the application layer may determine that the terminal is required to be switched from the inactive state to the idle state.

Exemplarily, a specific scenario is as follows. When there is signaling to be transmitted/received in the NAS, it is indicated that the terminal is required to perform signaling transmission with a core network, and the NAS determines that the terminal may be required to subsequently transmit signaling, so that the terminal is not required to be switched from the inactive state to the idle state, the terminal is kept in the inactive state, and when signaling is subsequently required to be transmitted, the terminal may be switched to the connected state. When there is no signaling to be transmitted/received in the NAS, it is indicated that the terminal is presently not required to perform signaling transmission with the network side, and the NAS determines that the terminal is presently not required to transmit signaling, so that the terminal may be switched from the inactive state to the idle state to cut off the connection between the terminal and the network side and reduce the energy consumption of the terminal.

During a practical application, another manner may be adopted to determine that the terminal is required to be switched from the inactive state to the idle state. There are no limits made thereto in the embodiment of the application.

In Step 202, the terminal sends a context release request to a first base station.

The context release request is used for indicating the network side to release the related context of the terminal. Optionally, the terminal may send the context release request to the first base station through the AS.

During the practical application, the terminal is required to establish an RRC connection with the first base station, and then may perform information interaction. A process of establishing an RRC connection between the terminal and the first base station may refer to FIG. 2-2 and includes the following steps.

In Step 2021, the terminal sends an RRC Connection Resume Request to the first base station.

Optionally, the terminal may send the RRC Connection Resume Request to the first base station according to a paging message received in advance.

In Step 2022, the first base station sends an RRC Connection Resume to the terminal.

In Step 2023, the terminal sends an RRC Connection Resume Complete message to the first base station.

The specific process of Step 2021 to Step 2023 may refer to an LTE RRC protocol 3GPP36.331 and will not be elaborated in the embodiment of the disclosure.

It is to be noted that, after the terminal completes establishing the RRC connection with the first base station, if handover failure, radio link failure, integrity protection failure, RRC reconfiguration failure or the like occurs, then the terminal may trigger an RRC connection reestablishment process. This process aims to reestablish an RRC connection, and may include recovery of a Signaling Radio Bear 1 (SRB1) operation, security reactivation and the like. Exemplarily, the terminal may send an RRC connection recovery request to the first base station, the first base station, after receiving the RRC connection recovery request, may send an RRC connection recovery response to the terminal according to the RRC connection recovery request, and the terminal, after receiving the RRC connection recovery response, may perform corresponding configuration according to the RRC connection recovery response and, after completing configuration, send an RRC connection recovery completion request to the first base station to notify the first base station to complete the RRC connection reestablishment process.

Optionally, the context release request in the embodiment of the disclosure may be new signaling, or may also be reused conventional signaling. When the context release request is reused conventional signaling, on one hand, referring to FIG. 2-2, the context release request may reuse signaling in the RRC connection resume process. For example, the context release request may be the RRC Connection Resume Request containing a release indication, or the context release request is the RRC Connection Resume Complete message containing the release indication. On the other hand, the context release request may reuse signaling in the RRC connection reestablishment process, for example, the context release request may be the RRC connection recovery request containing the release indication, or the context release request may be the RRC connection recovery completion request containing the release indication.

Here, the release indication is used for indicating the network side to release the related context of the terminal. The form of the release indication may be matched with a present RRC protocol, and the message containing the release indication may be used for the terminal to trigger the network side to release the related context.

In Step 203, the first base station sends a context release authorization request to a core management device according to the context release request.

In the embodiment of the disclosure, the first base station may send the context release authorization request to the core management device to request the core management device for authorizing a network-side device to release the context. Optionally, the context release authorization request may also contain the release indication.

In Step 204, the core management device generates a context release authorization response according to the context release authorization request.

The core management device may determine whether to allow the network-side device to release the related context or not according to the context release authorization request. Exemplarily, the core management device may predict whether the terminal transmits data within a preset time period or not. If it is predicted that the terminal transmits data within the preset time period, the network-side device is not allowed to release the related context, thereby avoiding the network resource waste caused by the connection reestablishment after the connection between the terminal and the network side is cut off. If it is predicted that the terminal does not transmit data within the preset time period, the network-side device is allowed to release the related context, so that a load of the network-side device may be reduced.

For example, the core management device counts down when receiving the context release authorization request, a countdown duration being equal to a duration of the preset time period, and if the core network receives a request for data transmission with the terminal before the end of countdown, it is predicted that there are data transmitted at the terminal within the preset time period.

In the embodiment of the disclosure, if the core management device determines to allow the network-side device to release the related context according to the context release authorization request, the core management device may generate a context release authorization response. The context release authorization response is used for indicating that the network-side device is allowed to release the related context.

In Step 205, the core management device sends a context release authorization response to the first base station.

A process of data transmission between the core management device and the first base station may refer to a related protocol and will not be limited in the embodiment of the disclosure.

In Step 206, the first base station sends context release indication information to a network-side device according to the context release authorization response.

Since the core management device allows the network-side device to release the context, the first base station may send the context release indication information according to the context release authorization response, the context release indication information being used for indicating the network-side device to release the related context. The first base station sends the context release indication information to the network-side device to trigger the network-side device to release the related context.

In Step 207, the network-side device releases a related context according to the context release indication information.

A release process of the related context is substantially a process that the network-side device deletes the related context, which may specifically refer to the contents in the related protocol and will not be elaborated in the embodiment of the disclosure.

In Step 208, the network-side device sends context release completion information to the first base station.

The network-side device, after completing releasing of the related context, may send the context release completion information to the first base station to notify the first base station. The context release completion information is used for indicating that the network-side device has completed releasing the related context.

In Step 209, the first base station sends a context release response to the terminal according to the context release completion information.

The first base station, after receiving the context release completion information, may send the context release response to the terminal to notify the terminal that the network-side device has completed releasing the related context. Here, contents in the context release completion information and the context release response may be the same or may be different.

In Step 210, the terminal releases the related context in the terminal according to the context release response.

In the embodiment of the disclosure, the terminal may release its own related context according to the context release response to reduce its own load. However, during the practical application, the terminal may not release its own related context. There are no limits made thereto in the embodiment of the disclosure.

It is to be noted that a sequence of the steps of the context release method provided in the embodiment may be properly regulated, the steps may be added or reduced according to a condition. Any method apparent to those skilled in the art within the technical scope of the disclosure shall fall within the scope of protection of the disclosure and thus will not be elaborated.

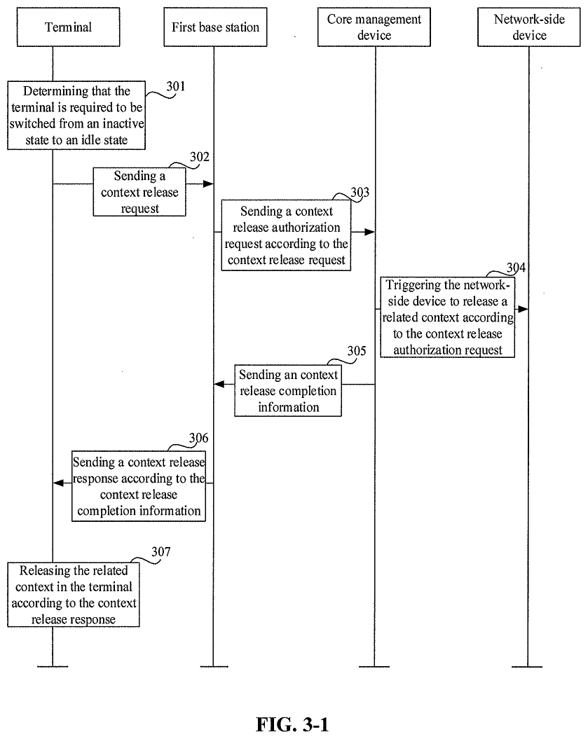

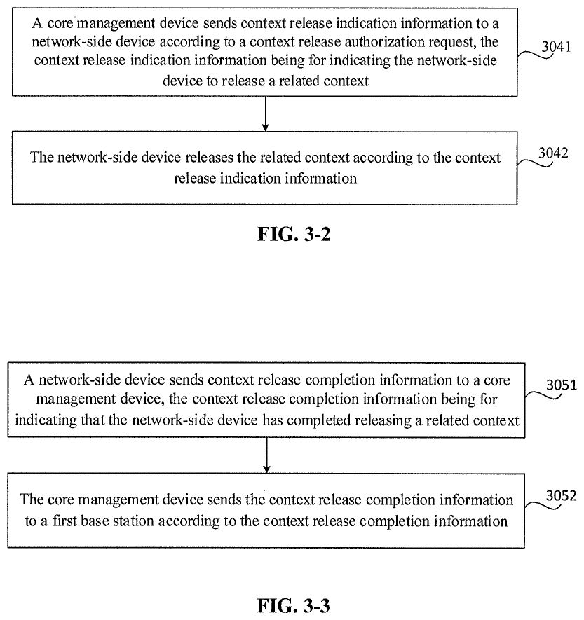

On a second aspect, the network-side device may be indirectly triggered by the core management device to release the related context, which, as shown in FIG. 3-1, specifically includes the following steps.

In Step 301, a terminal determines that the terminal is required to be switched from an inactive state to an idle state.

A specific process of Step 301 may refer to Step 201 and will not be elaborated in the embodiment of the disclosure.

In Step 302, the terminal sends a context release request to a first base station.

The context release request is used for indicating a network side to release a related context of the terminal. The other contents in Step 302 may refer to Step 202 and will not be elaborated in the embodiment of the disclosure.

In Step 303, the first base station sends a context release authorization request to a core management device according to the context release request.

The context release authorization request is used for requesting for authorization to be given to a network-side device to release the related context. The other contents in Step 303 may refer to Step 203 and will not be elaborated in the embodiment of the disclosure.

In Step 304, the core management device triggers a network-side device storing the related context to release the related context according to the context release authorization request.

Optionally, referring to FIG. 3-2, the process that the core management device triggers the network-side device storing the related context to release the related context according to the context release authorization request may include the following steps.

In Step 3041, the core management device sends context release indication information to the network-side device according to the context release authorization request, the context release indication information being used for indicating the network-side device to release the related context.

The core management device may determine whether to allow the network-side device to release the related context or not according to the context release authorization request. Exemplarily, the core management device may predict whether the terminal transmits data within a preset time period or not. If it is predicted that the terminal transmits data within the preset time period, the network-side device is not allowed to release the related context, thereby avoiding the network resource waste caused by connection reestablishment after the connection between the terminal and the network side is cut off. If it is predicted that the terminal does not transmit data within the preset time period, the network-side device is allowed to release the related context, so that a load of the network-side device may be reduced.

For example, the core management device counts down when receiving the context release authorization request, a countdown duration being equal to a duration of the preset time period, and if the core network receives a request for transmitting data to the terminal before the end of countdown, it is predicted that there are data transmitted at the terminal within the preset time period.

In the embodiment of the disclosure, if the core management device determines to allow the network-side device to release the related context according to the context release authorization request, the core management device may send the context release indication information to the network-side device to trigger the network-side device to release the related context.

In Step 3042, the network-side device releases the related context according to the context release indication information.

Step 3042 may refer to Step 207 and will not be elaborated in the embodiment of the disclosure.

In Step 305, the core management device sends context release completion information to the first base station.

The context release completion information is used for indicating that the network-side device has completed releasing the related context.

Optionally, referring to FIG. 3-3, the process that the core management device sends the context release completion information to the first base station may include the following steps.

In Step 3051, the network-side device sends the context release completion information to the core management device, the context release completion information being used for indicating that the network-side device has completed releasing the related context.

The network-side device, after completing releasing the related context, may send the context release indication information to the core management device to notify the core management device.

In Step 3052, the core management device sends the context release completion information to the first base station according to the context release completion information.

The core management device, when receiving the context release completion information, may send the context release completion information to the first base station to notify the first base station that the network-side device has completed releasing the related context.

It is to be noted that the context release completion information sent by the network-side device and the context release completion information sent by the core management device may be the same or may be different.

In Step 306, the first base station sends a context release response to the terminal according to the context release completion information.

Step 306 may refer to Step 209 and will not be elaborated in the embodiment of the disclosure.

In Step 307, the terminal releases the related context in the terminal according to the context release response.

Step 307 may refer to Step 210 and will not be elaborated in the embodiment of the disclosure.

It is to be noted that a sequence of the steps of the context release method provided in the embodiment may be properly regulated, the steps also may be added or reduced according to a condition. Any method apparent to those skilled in the art within the technical scope of the disclosure shall fall within the scope of protection of the disclosure and thus will not be elaborated.

On a third aspect, the first base station may directly trigger the network-side device to release the related context, which, as shown in FIG. 4, specifically includes the following steps.

In Step 401, a terminal determines that the terminal is required to be switched from an inactive state to an idle state.

A specific process of Step 401 may refer to Step 201 and will not be elaborated in the embodiment of the disclosure.

In Step 402, the terminal sends a context release request to a first base station.

The context release request is used for indicating a network side to release a related context of the terminal. The other contents in Step 402 may refer to Step 202 and will not be elaborated in the embodiment of the disclosure.

In Step 403, the first base station sends context release indication information to a network-side device according to the context release request.

The first base station may send the context release indication information to the network-side device to trigger the network-side device to release the related context according to the context release request. The context release indication information is used for indicating the network-side device to release the related context.

In Step 404, the network-side device releases a related context according to the context release indication information.

Step 404 may refer to Step 207 and will not be elaborated in the embodiment of the disclosure.

In Step 405, the network-side device sends context release completion information to the first base station.

The context release completion information is used for indicating that the network-side device has completed releasing the related context. The other contents in Step 405 may refer to Step 208 and will not be elaborated in the embodiment of the disclosure.

In Step 406, the first base station sends a context release response to the terminal according to the context release completion information.

Step 406 may refer to Step 209 and will not be elaborated in the embodiment of the disclosure.

In Step 407, the terminal releases the related context in the terminal according to the context release response.

Step 407 may refer to Step 210 and will not be elaborated in the embodiment of the disclosure.

It is to be noted that a sequence of the steps of the context release method provided in the embodiment may be properly regulated, the steps may be added or reduced according to a condition. Any method apparent to those skilled in the art within the technical scope of the disclosure shall fall within the scope of protection of the disclosure and thus will not be elaborated.

In a related art, it is also proposed that a release indication may also be directly added into a paging message sent by the network side to enable the terminal to directly release the related context and enter the idle state. However, a new method for the terminal to trigger the network side to release the related context is provided in the embodiment of the disclosure, so that release flexibility of the related context is improved.

From the above, according to the context release method provided in the embodiments of the disclosure, the terminal triggers the network side to release the related context, and in a context release process, particularly a context release process in the inactive state, switching to the connected state for switching to the idle state is avoided, so that signaling interaction between the terminal and the network side is effectively reduced, a signaling overhead is reduced, and the whole flow is simplified.

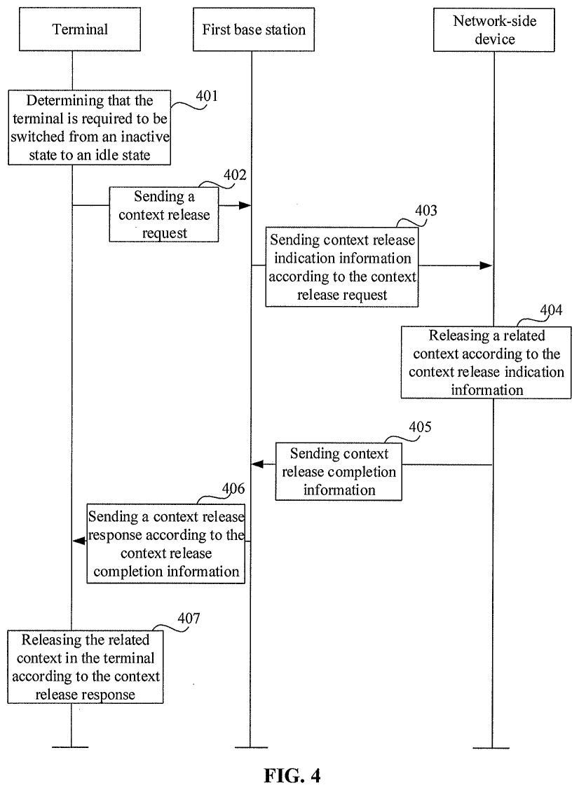

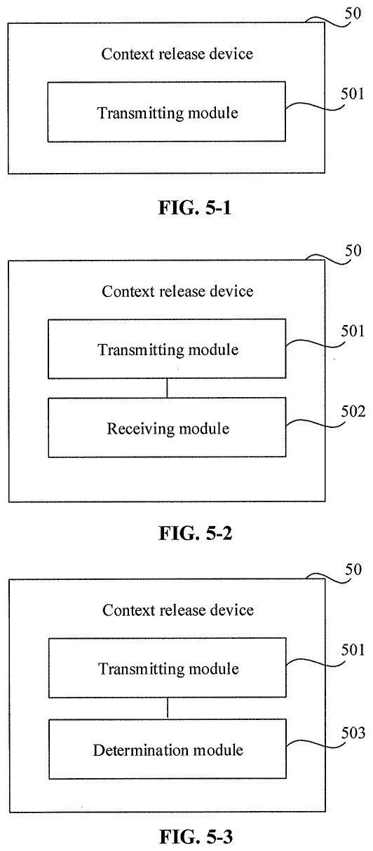

An embodiment of the disclosure provides a context release device 50, which, as shown in FIG. 5-1, includes a transmitting module 501.

The transmitting module 501 is configured to send a context release request to a first base station, the context release request being used for indicating a network side to release a related context of a terminal.

From the above, according to the context release device provided in the embodiment of the disclosure, the transmitting module triggers the network side to release the related context, and in a context release process, particularly a context release process in an inactive state, switching to a connected state for switching to an idle state is avoided, so that signaling interaction between the terminal and the network side is effectively reduced, a signaling overhead is reduced, and the whole flow is simplified.

Furthermore, as shown in FIG. 5-2, the device 50 further includes a receiving module 502.

The receiving module 502 is configured to receive a context release response from the first base station.

Optionally, as shown in FIG. 5-3, the device 50 further includes a determination module 503.

The determination module 503 is configured to determine, through an application layer or a NAS, that the terminal is required to be switched from an inactive state to an idle state.

Here, the transmitting module 501 is specifically configured to:

send the context release request to the first base station through an AS.

Optionally, the context release request is an RRC Connection Resume Request containing a release indication; or, the context release request is an RRC connection recovery request containing the release indication; or, the context release request is an RRC Connection Resume Complete message containing the release indication; or, the context release request is an RRC connection recovery completion request containing the release indication.

Here, the release indication is used for indicating the network side to release the related context of the terminal.

From the above, according to the context release device provided in the embodiment of the disclosure, the transmitting module triggers the network side to release the related context, and in the context release process, particularly the context release process in the inactive state, switching to the connected state for switching to the idle state is avoided, so that signaling interaction between the terminal and the network side is effectively reduced, the signaling overhead is reduced, and the whole flow is simplified.

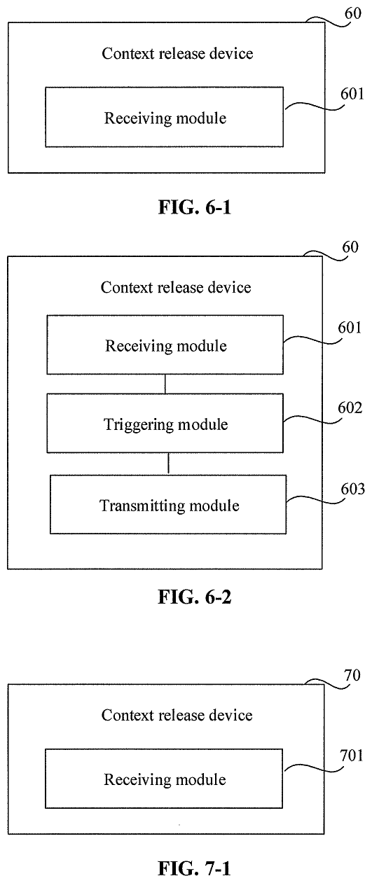

An embodiment of the disclosure provides a context release device 60, which, as shown in FIG. 6-1, includes a receiving module 601.

The receiving module 601 is configured to receive a context release request from a terminal, the context release request being used for indicating a network side to release a related context of the terminal.

From the above, according to the context release device provided in the embodiment of the disclosure, the terminal triggers the network side to release the related context, and in a context release process, particularly a context release process in an inactive state, switching to a connected state for switching to an idle state is avoided, so that signaling interaction between the terminal and the network side is effectively reduced, a signaling overhead is reduced, and the whole flow is simplified.

Furthermore, as shown in FIG. 6-2, the device 60 further includes a triggering module 602 and a transmitting module 603.

The triggering module 602 is configured to trigger a network-side device storing the related context to release the related context according to the context release request.

The transmitting module 603 is configured to send a context release response to the terminal, the context release response being configured to trigger the terminal to release the related context.

On one aspect, the triggering module 602 is specifically configured to:

send context release indication information to the network-side device according to the context release request, the context release indication information being used for indicating the network-side device to release the related context.

The transmitting module 603 is specifically configured to:

receive context release completion information from the network-side device, the context release completion information being used for indicating that the network-side device has completed releasing the related context, and

send the context release response to the terminal according to the context release completion information.

On another aspect, the triggering module 602 is specifically configured to:

send a context release authorization request to a core management device according to the context release request, the context release authorization request being configured to request for authorizing the network-side device to release the related context.

The transmitting module 603 is specifically configured to:

receive the context release completion information from the core management device, the context release completion information being sent by the core management device after triggering the network-side device to release the related context and being used for indicating that the network-side device has completed releasing the related context, and

send the context release response to the terminal according to the context release completion information.

On another aspect, the triggering module 602 is specifically configured to: send the context release authorization request to the core management device according to the context release request, the context release authorization request being configured to request for authorizing the network-side device to release the related context,

receive a context release authorization response sent by the core management device, the context release authorization response being used for indicating that the network-side device is allowed to release the related context, and

send the context release indication information to the network-side device according to the context release authorization response, the context release indication information being used for indicating the network-side device to release the related context.

The transmitting module 603 is specifically configured to:

receive the context release completion information sent by the network-side device, the context release completion information being used for indicating that the network-side device has completed releasing the related context, and

send the context release response to the terminal according to the context release completion information.

Optionally, the context release request is an RRC Connection Resume Request containing a release indication; or, the context release request is an RRC connection recovery request containing the release indication; or, the context release request is an RRC Connection Resume Complete message containing the release indication; or, the context release request is an RRC connection recovery completion request containing the release indication.

Here, the release indication is used for indicating the network side to release the related context of the terminal.

Optionally, the context release request is sent by the terminal accessing a first base station after the terminal determines that the terminal is required to be switched from an inactive state to an idle state.

Optionally, the network-side device includes an initial base station, and/or, a management device of a core network, and/or, a network-side central control node.

The initial base station is a base station to which a cell where the terminal having not yet been switched to the inactive state is located belongs.

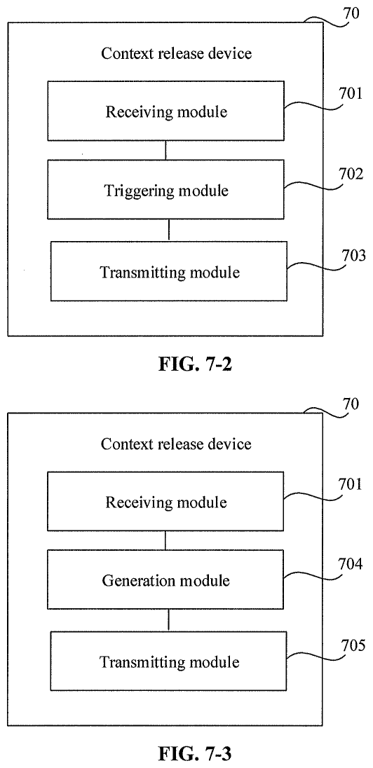

An embodiment of the disclosure provides a context release device 70, which, as shown in FIG. 7-1, includes a receiving module 701.

The receiving module 701 is configured to receive a context release authorization request sent by a first base station, the context release authorization request being sent by the first base station after the first base station receives a context release request from a terminal and the context release request being used for indicating a network side to release a related context of the terminal.

From the above, according to the context release device provided in the embodiment of the disclosure, the terminal triggers the network side to release the related context, and in a context release process, particularly a context release process in an inactive state, switching to a connected state for switching to an idle state is avoided, so that signaling interaction between the terminal and the network side is effectively reduced, a signaling overhead is reduced, and the whole flow is simplified.

On one aspect, as shown in FIG. 7-2, the device further includes a triggering module 702 and a transmitting module 703.

The triggering module 702 is configured to trigger a network-side device storing the related context to release the related context according to the context release authorization request.

The transmitting module 703 is configured to send context release completion information to the first base station after the network-side device releases the related context, the context release completion information being used for indicating that the network-side device has completed releasing the related context.

Here, the triggering module 702 is specifically configured to:

send context release indication information to the network-side device according to the context release authorization request, the context release indication information being used for indicating the network-side device to release the related context.

The transmitting module 703 is specifically configured to:

receive the context release completion information from the network-side device, the context release completion information being used for indicating that the network-side device has completed releasing the related context, and

send the context release completion information to the first base station according to the context release completion information.

On another aspect, as shown in FIG. 7-3, the device 70 further includes a generation module 704 and a transmitting module 705.

The generation module 704 is configured to generate a context release authorization response according to the context release authorization request, the context release authorization response being used for indicating that the network-side device is allowed to release the related context.

The transmitting module 705 is configured to send the context release authorization response to the first base station.

Optionally, the context release request is sent by the terminal in a cell managed by the first base station after the terminal determines that the terminal is required to be switched from an inactive state to an idle state.

Optionally, the network-side device includes an initial base station, and/or, a management device of a core network, and/or, a network-side central control node.

The initial base station is a base station to which a cell where the terminal having not yet been switched to the inactive state is located belongs.

An embodiment of the disclosure provides a context release system, which includes a terminal and a first base station.

The terminal may include any context release device of FIGS. 5-1 to 5-3.

The first base station may include any context release device of FIGS. 6-1 to 6-2.

Furthermore, the system further includes any context release device of FIGS. 7-1 to 7-3.

From the above, according to the context release system provided in the embodiment of the disclosure, the terminal triggers a network side to release a related context, and in a context release process, particularly a context release process in an inactive state, switching to a connected state for switching to an idle state is avoided, so that signaling interaction between the terminal and the network side is effectively reduced, a signaling overhead is reduced, and the whole flow is simplified.

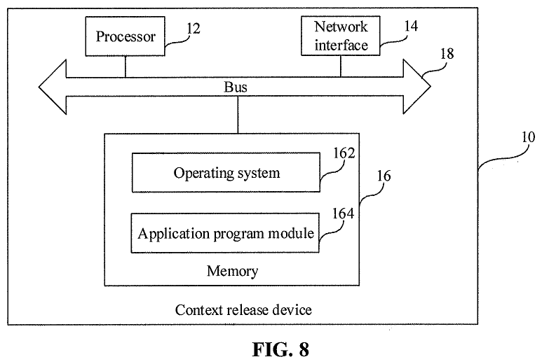

FIG. 8 is a structure diagram of a context release device 10 according to an exemplary embodiment of the disclosure. The context release device 10 may be a first base station 110, a network-side device 120, a core management device 130 or a terminal. The network device 10 includes a processor 12 and a network interface 14.

The processor 12 includes one or more than one processing cores. The processor 12 runs a software program and a module, thereby executing various functional applications and data processing.

There may be multiple network devices 14. The network device 14 is configured to communicate with another storage device or network device.

Optionally, the network device 10 further includes components such as a memory 16 and a bus 18. Here, the memory 16 and the network interface 14 are connected with the processor 12 through the bus 18 respectively.

The memory 16 may be configured to store the software program and the module. Specifically, the memory 16 may store an operating system 162 and an application program module 164 required by at least one function. The operating system 162 may be an operating system such as a real-time operating system (Real Time eXecutive (RTX), LINUX, UNIX, WINDOWS or OS X.

In some implementation modes, when the context release device 10 is the first base station, the network interface 14 may be a transceiver antenna (which may also be considered as a transmitter and a receiver), and the application program module 164 stored in the memory 16 may execute steps such as steps 203, 206, 209, 303, 306, 403 or 406.

When the context release device 10 is the terminal, the network interface 14 may be a transceiver antenna (which may also be considered as a transmitter and a receiver), and the application program module 164 stored in the memory 16 may execute steps 201, 202, 210, 301, 302, 307, 401, 402 or 407 and the like.

When the context release device 10 is the core management device, the application program module 164 stored in the memory 16 may execute steps such as steps 204, 202, 210, 304 and 305.

Those skilled in the art may clearly learn about that specific working processes of the system, devices and modules described above may refer to the corresponding processes in the method embodiments and will not be elaborated herein for convenient and brief description.

In the embodiments of the disclosure, the term “and/or” is only an association relationship describing associated objects and represents that three relationships may exist. For example, A and/or B may represent three conditions: i.e., independent existence of A, existence of both A and B and independent existence of B. In addition, character “/” in the disclosure usually represents that previous and next associated objects form an “or” relationship.

Those of ordinary skill in the art should understand that all or part of the steps of the abovementioned embodiments may be completed through hardware, or may also be completed through the hardware instructed by a program, the program may be stored in a computer-readable storage medium, and the storage medium may be a read-only memory, a magnetic disk, an optical disk or the like.

The above are only the preferred embodiments of the disclosure and not intended to limit the disclosure. Any modifications, equivalent replacements, improvements and the like made within the spirit and principle of the disclosure shall fall within the scope of protection of the disclosure.

1.-19. (canceled)

20. A context release device, comprising a network interface; wherein
the network interface is configured to send a context release request to a first base station,
wherein the context release request is used for indicating a network side to release a related context of a terminal.

21. The device of claim 20,
wherein the network interface is further configured to receive a context release response sent by the first base station.

22. The device of claim 20, further comprising:
a processor; and
a memory configured to store programs executable by the processor to implement an operation of:
determining, through an application layer or a Non-Access Stratum (NAS), that the terminal is required to be switched from an inactive state to an idle state.

23. The device of claim 20, wherein the network interface is configured to:
send the context release request to the first base station through an Access Stratum (AS).

24. The device of claim 20, wherein
the context release request is a Radio Resource Control (RRC) Connection Resume Request containing a release indication; or,
the context release request is an RRC connection recovery request containing a release indication; or,
the context release request is an RRC Connection Resume Complete message containing a release indication; or,
the context release request is an RRC connection recovery completion request containing a release indication,
wherein the release indication is used for indicating the network side to release the related context of the terminal.

25. A context release device, comprising a network interface configured to:
receive a context release request from a terminal,
wherein the context release request is used for indicating a network side to release a related context of the terminal.

26. The device of claim 25, further comprising:
a processor; and
a memory configured to store programs executable by the processor to implement an operation of:
triggering a network-side device storing the related context to release the related context according to the context release request;
the network interface is configured to send a context release response to the terminal, wherein the context release response is used for triggering the terminal to release the related context.

27. The device of claim 26, wherein
the processor is specifically configured to:
control the network interface to send context release indication information to the network-side device according to the context release request, wherein the context release indication information is used for indicating the network-side device to release the related context; and
the network interface is specifically configured to:
receive context release completion information from the network-side device, wherein the context release completion information is used for indicating that the network-side device has completed releasing the related context, and
send the context release response to the terminal according to the context release completion information.

28. The device of claim 26, wherein
the processor is specifically configured to:
control the network interface to send a context release authorization request to a core management device according to the context release request, wherein the context release authorization request is used for requesting for authorizing the network-side device to release the related context; and
the network interface is specifically configured to:
receive context release completion information from the core management device, wherein the context release completion information is sent by the core management device after the core management device triggers the network-side device to release the related context and is used for indicating that the network-side device has completed releasing the related context, and
send the context release response to the terminal according to the context release completion information.

29. The device of claim 26, wherein
the processor is specifically configured to:
control the network interface to send a context release authorization request to a core management device according to the context release request, wherein the context release authorization request is used for requesting for authorizing the network-side device to release the related context,
control the network interface to receive a context release authorization response sent by the core management device, wherein the context release authorization response is used for indicating that the network-side device is allowed to release the related context, and
control the network interface to send context release indication information to the network-side device according to the context release authorization response, wherein the context release indication information is used for indicating the network-side device to release the related context; and
the network interface is specifically configured to:
receive context release completion information sent by the network-side device, wherein the context release completion information is used for indicating that the network-side device has completed releasing the related context, and
send the context release response to the terminal according to the context release completion information.

30. The device of claim 25, wherein
the context release request is a Radio Resource Control (RRC) Connection Resume Request containing a release indication; or,
the context release request is an RRC connection recovery request containing a release indication; or,
the context release request is an RRC Connection Resume Complete message containing a release indication; or,
the context release request is an RRC connection recovery completion request containing a release indication,
wherein the release indication is used for indicating the network side to release the related context of the terminal.

31. The device of claim 25, wherein
the context release request is sent by the terminal accessing a first base station after the terminal determines that the terminal is required to be switched from an inactive state to an idle state.

32. The device of claim 26, wherein
the network-side device comprises at least one of: an initial base station, a management device of a Core Network, or a network-side central control node; and
the initial base station is a base station to which a cell where the terminal having not yet been switched to an inactive state is located belongs.

33. A context release device, comprising a network interface configured to:
receive a context release authorization request sent by a first base station,
wherein the context release authorization request is sent by the first base station after the first station receives a context release request from a terminal and the context release request is used for indicating a network side to release a related context of the terminal.

34. The device of claim 33, further comprising:
a processor; and
a memory configured to store programs executable by the processor to implement an operation of:
triggering a network-side device storing the related context to release the related context according to the context release authorization request; and
the network interface is configured to send context release completion information to the first base station after the network-side device releases the related context, wherein the context release completion information is used for indicating that the network-side device has completed releasing the related context.

35. The device of claim 34, wherein
the processor is configured to:
control the network interface to send context release indication information to the network-side device according to the context release authorization request, wherein the context release indication information is used for indicating the network-side device to release the related context; and
the network interface is configured to:
receive the context release completion information from the network-side device, wherein the context release completion information is used for indicating that the network-side device has completed releasing the related context, and
send the context release completion information to the first base station according to the context release completion information.

36. The device of claim 33,
wherein the processor is further configured to generate a context release authorization response according to the context release authorization request, wherein the context release authorization response is used for indicating that the network-side device storing the related context is allowed to release the related context; and
the network interface is configured to send the context release authorization response to the first base station.

37. The device of claim 33, wherein
the context release request is sent by the terminal in a cell managed by the first base station after the terminal determines that the terminal is required to be switched from an inactive state to an idle state.

38. The device of claim 34, wherein
the network-side device comprises at least one of: an initial base station, a management device of a Core Network, or a network-side central control node; and
the initial base station is a base station to which a cell where the terminal having not yet been switched to an inactive state is located belongs.

39. A context release system, comprising a terminal and a first base station, wherein
the terminal comprises a context release device of comprising a network interface configured to send a context release request to a first base station, the context release request being used for indicating a network side to release a related context of a terminal; and
the first base station comprises the context release device of claim 25.

40. (canceled)
